(19) United States
(12) Patent Application Publication
(10) Pub. No.: US 2004/0156960 A1
(43) Pub. Date: Aug. 12, 2004

(54) Food product preservation method

(75) Inventors: Ricardo Villota, Lake Zurich, IL (US); Yeong-Ching Albert Hong, Kildeer, IL (US); Jimbay P. Loh, Green Oaks, IL (US); Raymond J. Laudano, Grayslake, IL (US); Metty P. Langston, Buffalo Grove, IL (US); Dalip K. Nayyar, Grayslake, IL (US); Michael G. Roman, Grayslake, IL (US); Guillermo Haro, Skokie, IL (US); James L. Bell, Evanston, IL (US); Michelle M. Voss, Buffalo Grove, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/361,357

(22) Filed: Feb. 10, 2003

(51) Int. Cl. A23K 1/00

(52) U.S. Cl. 426/325

(57) ABSTRACT

This invention relates to a method for preservation of food products, especially vegetables, acidification, pasteurization, and refrigeration. In one embodiment, this invention relates to a method for obtaining a preserved food product comprising (1) placing a food product in a sealable, heat stable container; (2) adding an amount of an edible acid to the container, wherein the amount is sufficient to achieve a pH of less than about 5 in the preserved food product; (3) sealing the container; (4) thermally treating the food product in the sealed container at a temperature and for a time effective to pasteurize the food product; (5) cooling the thermally treated food product to rapidly reduce the temperature to below about 55° F.; and (6) storing the cooled food product under refrigerated conditions to obtain the preserved food product. When cooked, the vegetables provided by this invention have appearance, texture, and taste superior to that provided by high quality cooked frozen vegetables, including individually quick frozen (IQF) vegetables.

### FIELD OF THE INVENTION

This invention relates to a methods for preservation of food products using acidification, pasteurization, and refrigeration. Using the methods of this invention, shelf lives of at least about 90 days under refrigerated storage conditions can be obtained without the use of preservatives and/or extensive thermal processing. More specifically, this invention relates to a method for preparing a preserved food product comprising (1) combining a food product with an amount of an edible acid to obtain an acidified food product, wherein the amount is sufficient to achieve a pH of about 4.6 to about 5 in the preserved food product; (2) placing the acidified food product in a heat-stable, sealable container; (3) sealing the container; (4) thermally treating the food product in the sealed-container at a temperature and for a time effective to pasteurize the food product; (5) cooling the thermally treated food product to rapidly reduce the temperature to below about 55° F.; and (6) storing the cooled food product under refrigerated conditions to obtain the preserved food product. The food products which can be treated using the methods of this invention include, for example, vegetables (raw or cooked), beans, rice, pasta, meat, and the like, as well as mixtures thereof.

In a preferred embodiment, this invention relates to a method for preservation of vegetables using in-package acidification and pasteurization. More specifically, this invention relates to a method for prepared preserved vegetables comprising (1) placing raw or partially cooked vegetables in a sealable, heat stable container; (2) adding an amount of an edible acid to the container, wherein the amount is sufficient to achieve a pH of about 4.6 to about 5 in the preserved vegetables; (3) sealing the container; (4) thermally treating the vegetables in the sealed container at a temperature and for a time effective to pasteurize the food product; (5) cooling the thermally treated vegetables to rapidly reduce the temperature to below about 55° F.; and (6) storing the cooled vegetables under refrigerated conditions to obtain the preserved vegetables.

The cooled vegetables or cooled food products are then stored under refrigerated conditions. The food product should not be exposed to ambient temperatures between the cooling step and the refrigeration step; in other words, the temperature of the food product should be maintained at about 55° F. or less during the period between the cooling step and the refrigeration step. More preferably, the food product after cooling is immediately (i.e., within about 10 minutes or more preferably within about 2 minutes) stored under refrigerated conditions. When cooked, the vegetables provided by this invention have appearance, texture, and taste superior to that provided by high quality frozen vegetables, including individually quick frozen (IQF) vegetables. Preferably the vegetables prepared by this invention include, but are not limited to, carrots, peppers, broccoli, peas, pea-pods, cauliflower, onions, tomatoes, mushrooms, zucchini, corn, celery, asparagus, green beans, water chestnuts, and bamboo shoots.

### BACKGROUND OF THE INVENTION

Fresh vegetables, especially when peeled or cut, deteriorate rapidly. Generally such vegetables experience lose of flavor, crispness, texture, fresh appearance, color, and/or other organoleptic properties. Conventional preservation processes (e.g., canning, freezing, pickling, infusion, conventional acidification, and the like) typically involve multiple heat treatment steps and/or a combination of heat treatment with other destructive processing steps to preserve the vegetables. Generally the accumulative effects of these preservation methods results in reduced quality. Numerous efforts have been made to provide preservation techniques and/or to modify existing techniques which mitigate such loses.

For example, storage stable intermediate moisture vegetables have been prepared using various techniques. Vegetable infusion techniques have been used to prepare intermediate moisture vegetables having improved characteristics. See, e.g., U.S. Pat. No. 3,623,893 (Nov. 30, 1971) (super-atmospheric pressures to infuse foods, including vegetables, with an aqueous infusion cocktail containing propylene glycol, potassium sorbate, glycerol, and salt); U.S. Pat. No. 3,745,027 (Jul. 10, 1973) (cooked vegetables in an infusion mixture containing, for example, glycerol, salt, propylene glycol, potassium sorbate, and water); U.S. Pat. No. 4,832,969 (May 23, 1989) (infusion cocktail containing a polyhydric alcohol, a sugar, an alkaline buffering system or agent, an inorganic bittering agent, a surfactant, salt, and an anti-oxidant); U.S. Pat. No. 5,925,395 (Jul. 20, 1999) (preservative solution containing water, calcium ions, and optionally ascorbic acid or erythorbic acid); U.S. Pat. No. 6,440,449 (Aug. 27, 2002) (method of infusing vegetables with phytochemicals, nutraccuticals, herbal extracts, and medicinals). More recently, U.S. Pat. No. 6,403,134 (Jun. 11, 2002) provided improved intermediate moisture vegetables using an infusion cocktail comprising an aqueous solution of (1) a water-soluble, predominantly lower molecular weight, low sweetness carbohydrate, (2) a polyhydric alcohol, (3) salt, (4) a non-inorganic sweetness depressant agents, and (5) nisin-containing whey derived from a nisin-producing culture.

Other techniques have also been used to prepare intermediate moisture vegetables. For example, U.S. Pat. No. 6,096,361 (Aug. 1, 2000) provides a method of preserving vegetables by cooling them rapidly to the vicinity of their freezing point and then slowly cooling them below their freezing point at a rate of 0.01 to 0.5° C./hour. U.S. Pat. No. 4,946,693 (Aug. 7, 1990) provides a process wherein the vegetables are blanched or cooked, preferably using a microwave oven, and then partially dried (i.e., water content of 45 to 55 percent). The dried vegetables are then dry mixed with salt (and optionally sodium glutamate if the vegetables are not cooked using a microwave oven); an anti-mycotic agent can also be added. U.S. Pat. No. 5,110,609 (May 5, 1992) provides a method for producing intermediate moisture vegetables wherein the vegetables are partially dehydrated to a moisture content of 26 to 60 percent and then stored in an oxygen free atmosphere. U.S. Pat. No. 5,910,331 (Jun. 8, 1999) provides a method whereby vegetables are pickled for several hours in a solution containing a monosaccharide, disaccharide, oligosaccharide, sugar alcohol, or polysaccharide and then quickly frozen.

Modified atmosphere techniques have also been used to help preserve vegetable quality. For example, U.S. Pat. No. 6,113,671 (Sep. 5, 2000) provides a method for the storage of perishable produce, including vegetables, wherein the atmosphere within a container was controlled using a plurality of absorbent beds to absorb water vapor, ethylene, carbon dioxide, and nitrogen. U.S. Pat. No. 6,342,261 (Jan. 29, 2002) provides a method of preserving food, including vegetables, using noble gas atmospheres.

U.S. Pat. No. 6,045,846 (Apr. 4, 2000) provides a method for sterilizing fresh produce by contacting the produce with an aqueous solution of an oxidizing agent (e.g., hydrogen peroxide) under a pressure of at least 25 psi for a time sufficient to significantly reduce the microbiological count. U.S. Pat. No. 6,004,601 (Dec. 21, 1999) provides a method for improving green color retention and texture in vegetables by blanching raw or IQF vegetable in an aqueous zinc solution for three minutes or less; the resulting vegetables may be frozen or dried. U.S. Pat. No. 6,146,683 (Nov. 14, 2000) provides a method for preparing a savory vegetable preparation by boiling coarsely chopped vegetables in an aqueous polydextrose solution.

Although these methods can provide improved vegetables, there remains a need for even further improvements. The present method provides such improvements. Indeed, the present method allows the preparation of vegetables which are shelf stable and which have significantly improved organoleptic properties. In taste tests, the vegetables prepared using the present method were often ranked as good as or even better than the original vegetables.

### SUMMARY OF THE INVENTION

This invention relates to methods for preservation of food products using acidification, pasteurization, and refrigeration. Using the methods of this invention, shelf lives of at least about 90 days under refrigerated storage can be obtained without the use of preservatives and/or extensive thermal processing. More specifically, this invention relates to a method for preparing a preserved food product comprising (1) combining a food product with an amount of an edible acid to form an acidified food product, wherein the amount is sufficient to achieve a pH of about 4.6 to about 5 in the preserved food product; (2) placing the acidified food product in a heat stable container; (3) sealing the container; (4) thermally treating the food product in the sealed container at a temperature and for a time effective to pasteurize the food product; (5) cooling the thermally treated food product to rapidly reduce the temperature to below about 55° F.; and (6) storing the cooled food product under refrigerated conditions to obtain the preserved food product. The food products which can be treated using the methods of this invention include, for example, vegetables (raw or cooked), beans, rice, pasta, meat, and the like, as well as mixtures thereof. The food product and edible acid can be combined in a separate container and then transferred to the heat stable container that is to be sealed or can be combined directly in the heat stable container.

In a preferred embodiment, this invention relates to a method for preservation of vegetables using in-package acidification and pasteurization. More specifically, this invention relates to a method for preparing preserved vegetables comprising (1) placing raw or partially cooked vegetables in a sealable, heat stable container; (2) adding an amount of an edible acid to the container, wherein the amount is sufficient to achieve a pH of about 4.6 to about 5 in the preserved vegetables; (3) sealing the container; (4) thermally treating the vegetables in the sealed container at a temperature and for a time effective to pasteurize the vegetables; (5) cooling the thermally treated vegetables to rapidly reduce the temperature to below about 55° F.; and (6) storing the cooled vegetables under refrigerated conditions to obtain the preserved vegetables.

The cooled vegetables or cooled food products are then stored under refrigerated conditions. The food product should not be exposed to ambient temperatures between the cooling step and the refrigeration step; in other words, the temperature of the food product should be maintained at about 55° F. or less during the period between the cooling step and the refrigeration step. More preferably, the food product after cooling is immediately (i.e., within about 10 minutes or more preferably within about 2 minutes) stored under refrigerated conditions. When cooked, the vegetables provided by this invention have appearance, texture, and taste superior to that provided by high quality frozen vegetables, including individually quick frozen (IQF) vegetables. Preferably the vegetables prepared by this invention include, but are not limited to, carrots, peppers, broccoli, peas, pea-pods, cauliflower, onions, tomatoes, mushrooms, zucchini, corn, celery, asparagus, green beans, water chestnuts, and bamboo shoots. In addition to providing superior quality vegetables, the present method also provides a very simple and cost effective method for preserving vegetables.

### BRIEF DESCRIPTION OF THE DRAWINGS

FIG. 1 is a flowchart illustrating one embodiment of the process of the present invention for preparing food products.

FIG. 2 is a flowchart illustrating a preferred embodiment of the process of the present invention for preparing vegetables.

### DETAILED DESCRIPTION OF THE INVENTION

This invention relates to a method for preservation of food products, especially vegetables, using acidification, pasteurization, and refrigeration. This invention relates to a method preparing a preserved food product comprising (1) combining a food product with an amount of an edible acid to form an acidified food product, wherein the amount is sufficient to achieve a pH of about 4.6 to about 5 in the preserved food product; (2) placing the acidified food product in a sealable, heat stable container; (3) sealing the container; (4) thermally treating the food product in the sealed container at a temperature and for a time effective to pasteurize the food product; (5) cooling the thermally treated food product to rapidly reduce the temperature to below about 55° F.; and (6) storing the cooled food product under refrigerated conditions to obtain the preserved food product. The food products which can be treated using the methods of this invention include vegetables (raw or cooked), cooked meat, rice, pasta, and the like, as well as mixtures thereof.

This invention also relates to a method for preparing preserved vegetables comprising (1) placing raw or partially cooked vegetables in a sealable, heat stable container; (2) adding an amount of an edible acid to the container, wherein the amount is sufficient to achieve a pH of about 4.6 to about 5 in the preserved vegetables; (3) sealing the container; (4) thermally treating the vegetables in the sealed container at a temperature and for a time effective to pasteurize the vegetables; (5) cooling the thermally treated vegetables to rapidly reduce the temperature to below about 55° F.; and (6) storing the cooled vegetables under refrigerated conditions to obtained the preserved vegetables.

The cooled vegetables or cooled food products are then stored under refrigerated conditions. The food product should not be exposed to ambient temperatures between the cooling step and the refrigeration step; in other words, the temperature of the food product should be maintained at about 55° F. or less during the period between the cooling step and the refrigeration step. More preferably, the food product after cooling is immediately (i.e., within about 10 minutes or more preferably within about 2 minutes) stored under refrigerated conditions. When cooked, the vegetables provided by this invention have appearance, texture, and taste superior to that provided by high quality cooked frozen vegetables, including individually quick frozen (IQF) vegetables. Preferably the vegetables prepared by this invention include, but are not limited to, carrots, peppers, broccoli, peas, pea-pods, cauliflower, onions, tomatoes, mushrooms, zucchini, corn, celery, asparagus, green beans, water chestnuts, and bamboo shoots.

The present invention provides a very simple and cost effective process for the preservation of food products. The present invention provides minimal thermal exposure of the food products. Especially for vegetable-containing food products, the present invention also provides for elimination of other quality-degrading treatments such as freezing, drying, retorting, canning, and the like to produce very high quality vegetable-containing food products which approach, and in some cases, exceed the quality of their IQF counterparts. Additionally, the process of this invention provides packaged food products, especially vegetable-containing food products, which, when stored under refrigerated conditions, maintain their quality for at least 90 days and generally on the order of about 4 to about 6 months under refrigerated conditions. Even longer shelf lives can be obtained using freezing storage conditions but with some loss of quality.

Preferably, the food products of this invention are contained in a heat stable, sealable plastic pouch such that the food products can be pasteurized directly in the pouch and later heated or cooked directly in the pouch (e.g., in a boiling water bath or in a microwave oven) by the ultimate consumer. Indeed, one of the advantages of the present invention is that refrigerated vegetables prepared by the process of this invention can be consumed as raw vegetable snacks or heated or cooked alone or with other ingredients as desired by the consumer to provide the taste, texture, and appearance of fresh vegetables. The food products of the present invention can be heated or cooked in the original container (e.g., pouch) or removed form the orignial container for heating or cooking alone or in combination with other ingredients.

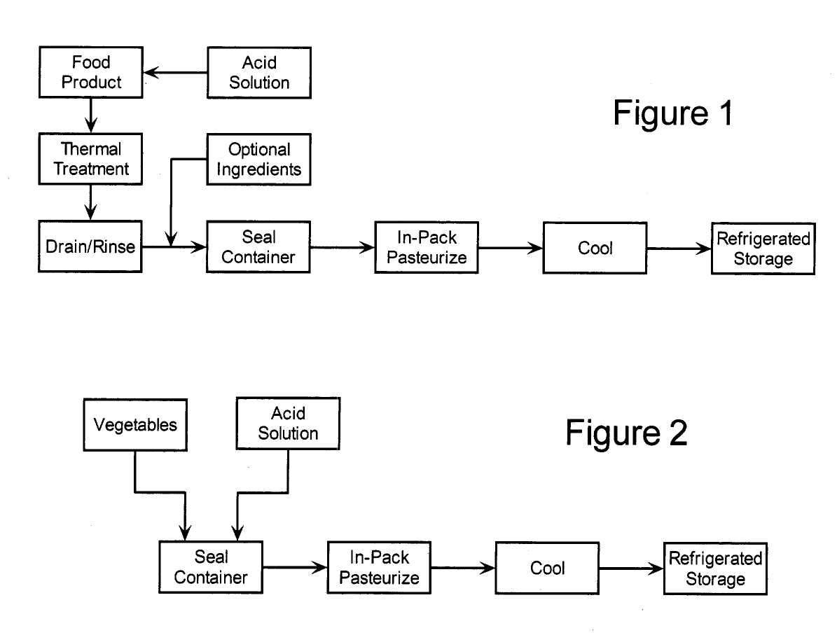

As illustrated in FIG. 1, the present invention provides a very simple and cost-effective process for the preservation of vegetables (as well as other food products). In this embodiment, acidification and pasteurization are conducted in separate process steps. The desired food products, preferably wherein the individual components are cut to the desired size, are combined with an acid solution. The pH of the acid solution is adjusted so that the pH of the final food product (i.e., the preserved food product) is in the range of about 4.6 to about 5. Generally the pH of the acid solution will be less than about 5 and preferably about 2 to about 4. The acidified food product is then subjected to thermal treatment. The thermal treatment can be effected by the acid solution being at a temperature in the range of about 180 to about 210° F. Alternatively, the thermal treatment may be effected by heating the food product and acid solution mixture to a similar temperature. In any event, the thermal treatment is continued until the pH is in the range of about 4.6 to about 5 and will generally be on the order of about 2.5 to about 5 minutes. Lower temperatures and/or lower pHs (so long as the final or equilibrium pH of the preserved food product is in the range of about 4.6 to about 5) can be used to improve product quality by minimizing thermal exposure. Optional ingredients can be added to the treated food product during or after this acidification step (i.e., the initial thermal treatment). Small amounts of optional ingredients, such as salt, sweetener, emulsifier, thickeners, spices, flavorants, colorants, preservatives, nutrients, vitamins, minerals, antioxidants, probiotics, botanicals, nutraceutical additives, and the like can be added during the initial thermal treatment or before the pasteurization step so long as they do not adversely effect the organoleptic and/or stability properties in a significant manner. For example, a relatively small amount (about 1 percent or less) of oxidatively stable oil (preferably vegetable oil) can be added, preferably near the end of the initial thermal treatment, to improve product appearance and handling characteristics. After draining excess hot acid solution, the treated food product is preferably rinsed with a cold acid solution (generally of similar composition to the original acid solution) to reduce the temperature to below about 55° F. The so-treated food product is then sealed in a heat stable container and then pasteurized. The container may, if desired, be sealed in a manner so as to at least reduce oxygen levels in the container (e.g., vacuum packing, inert atmosphere, and the like) in order to provide additional protection against oxidative flavor deterioration.

Generally pasteurization is effected by thermally treating the food product to effectively raise the temperature of the food product to at least about 160° F. for at least one minute (or equivalent pasteurization conditions). Generally, pasteurization can be carried out by heating the sealed container in a hot water bath at about 180 to about 210° F. for about 10 to about 40 minutes, and more preferably at about 190 to about 200° F. for about 15 to about 30 minutes. After pasteurization, the food product is rapidly cooled to below about 55° F. (preferably about 40 to about 55° F.) within about 10 minutes (preferably within about 2 minutes) and then stored under refrigeration conditions. The food product should not be exposed to ambient temperatures between the cooling step and the refrigeration step; in other words, the temperature of the food product should be maintained at about 55° F. or less during the period between the cooling step and the refrigeration step. More preferably, the food product after cooling is immediately (i.e., within about 10 minutes or more preferably within about 2 minutes) stored under refrigerated conditions.

An especially preferred process for the preparation of food products, especially vegetables or vegetable-containing food products, is illustrated in FIG. 2. In this embodiment, acidification and pasteurization are conducted at essentially the same time in order to minimize total thermal exposure of the food product. The desired food products, preferably wherein the individual components are cut to the desired size, are combined with an acid solution at the desired ratio (i.e., sufficient acid to provide the desired pH in the final preserved product). The food product and acid solution may be combined in a separate step and then placed in the desired heat stable container or added or combined directly in the desired heat stable container. The pH of the acid solution is adjusted so that the pH of the final preserved food product is in the range of about 4.6 to about 5. Generally the pH of the acid solution will be less than about 5 and preferably about 2 to about 4. Optional ingredients can be added to the treated food product via the acid solution or at any time before sealing the container. Small amounts of optional ingredients, such as salt, sweeteners, emulsifiers, thickeners, spices, flavorants, colorants, preservatives, nutrients, vitamins, minerals, antioxidants, probiotics, botanicals, nutraceutical additives, and the like can be added during the initial thermal treatment or before the pasteurization step so long as they do not adversely effect the organoleptic and/or stability properties in a significant manner. For example, a relatively small amount (about 1 percent or less) of oxidatively stable oil (preferably vegetable oil) can be added to improve product appearance and handling characteristics.

The food product and acid solution, along with any added optional ingredients, are sealed in the heat stable container and then pasteurized. The container may, if desired, be sealed in a manner so as to at least reduce oxygen levels in the container (e.g., vacuum packing, inert atmosphere, and the like) in order to provide additional protection against oxidative flavor deterioration. Generally pasteurization is effected by thermally treating the food product to effectively raise the temperature of the food product to at least about 160° F. for at least one minute (or equivalent pasteurization conditions). Generally, pasteurization can be carried out by heating the sealed container in a hot water bath at about 180 to about 210° F. for about 10 to about 40 minutes, and more preferably at about 190 to about 200° F. for about 15 to about 30 minutes. After pasteurization, the food product is rapidly cooled to below about 55° F. (preferably about 40 to about 55° F.) within about 10 minutes (preferably within about 2 minutes) and then stored under refrigeration conditions.

Generally, vegetables are cut into appropriate sizes (generally ½ inch or less in their longest dimension); larger pieces can be used, if desired. For fresh vegetables, a pretreatment step (not shown in FIGS. 1 and 2) to reduce the initial microbiological load is generally preferred. Such pretreatment steps could include, for example, washing, chlorine treatment, oxone treatment, UV treatment, or the like or combinations thereof. If used, it is generally preferred that any such pretreatment steps are carried out before the vegetables are cut or otherwise sized reduced; in other words, it is generally preferred that such pretreatment occur, to the extend possible, before the natural covering or protective skin is removed or pierced.

Generally, it is desirable that the pasteurization step should increase the internal temperature of the food product to at least about 160° F. for about one minute (or equivalent pasteurization conditions). In the case of vegetable-containing food products, this heat treatment step also inactivates enzymes (e.g., peroxidase, catalase, and the like) present in the vegetables. Any conventional method may be used to achieve this heat treatment step, including, for example, immersion of the filled container in hot or boiling water, microwave heating, retort heating, and the like.

It is generally preferred that the amount of food product within the container be kept relatively small (i.e., single to about 4 servings per container) so that the desired internal temperature can be achieved in the center of the package without exposing the remaining contents (i.e., the outer layers) to excessive periods of elevated temperatures. In other words, the package size and the amount of food product contained therein are preferably controlled so as to minimize the thermal exposure while still providing sufficient thermal energy for pasteurization for the entire contents of the package. After pasteurization, the temperature of the food product should be reduced rapidly to below about 55° F. (or lower and preferably about 40 to about 55° F.) to prevent degradation of the food product. For purposes of this invention, rapid temperature reduction is generally effected by reducing the temperature from the pasteurization temperature to below about 55° F. in less than about 10 minutes and preferably less than about 2 minutes. Of course, the cooling rate is not critical so long as the rate is sufficiently fast so that the quality of the food product is not significantly impaired. Cooling can be effected using conventional techniques including, for example, coolers, chillers, cold water rinses or baths, and the like. Once the package is sufficiently cooled, it should be placed and maintained under refrigerated conditions (generally about 35 to 40 about ° F.) until used by the ultimate consumer. Freezing will, of course, extend the shelf life of the product but will also reduce the quality of the product and, thus, is generally not preferred.

The amount of edible acid added should be sufficient to provide a pH in the final preserved food product of about 4.6 to about 5, preferably about 4.7 to about 4.8. Generally, a pH of greater than 5 in the final product will not provide the desired microbiological stability and a pH of less than 4.6, although providing microbiological stability, will have an “acid” taste and not be acceptable. Of course, the amount of edible acid to achieve such pH ranges in the final product can be determined experimentally and will depend, at least in part, on the buffering capacity, if any, of the particular food product used. Suitable edible acids include acetic acid, lactic acid, phosphoric acid, tartaric acid, glucono delta lactone, and the like. Preferably, the edible acid is lactic acid. Preferably the edible acid is added as an aqueous solution in either a liquid or solid (i.e., frozen) form; of course, it can added in other physical forms (e.g., solid powder or tablets) or in a mixture with a carrier consiting of a desired optional ingredient (e.g., salt, sugar, spice, and the like).

As noted above, the acid solution may also contain other optional ingredients or components such as, for example, salts, sweeteners, emulsifiers, thickeners, spices, flavorants, colorants, preservatives, nutrients, vitamins, minerals, antioxidants, probiotics, botanicals, nutraceutical additives, and the like so long as they do not adversely effect the organoleptic and/or stability properties in a significant manner. Thus, the acid solution may be a low viscosity solution, a low viscosity marinade, a medium or high viscosity sauce, and the like. Suitable salts include, for example, sodium chloride as well as other common salts (e.g., calcium chloride and the like) which may be added for purposes other than providing a “salty taste.” Suitable natural and artificial sweeteners include, for example sucrose, fructose, corn syrup, acesulfame K, sucralose, and the like. Suitable thickeners include, for example, gums and starches. Suitable oils include edible flavored or unflavored oils. Oxidative stable vegetable oils (e.g., olive oil, conola oil, and the like) are preferred. Emulsifiers (e.g., lecithin) may be included to enhance mouthfeel or reduce sticking. Suitable vitamins that may be included in the acid solution include, for example, vitamin A, vitamin C, vitamin D, vitamin E, B vitamins, niacin, folate, folic acid, and the like as well as mixtures thereof. Suitable minerals include, for example, salts of metal nutrients, wherein the metals are chosen from among calcium, magnesium, copper, iron, zinc, chromium, and the like as wells as mixtures thereof; salts of inorganic minerals such as, for example, phosphate, sulfate, chloride, and the like as well as mixtures thereof can also be used. Suitable antioxidants include, for example propyl gallate, octyl gallate, dodecyl gallate, butylated hydroxyanisole, butylated hydroxytoluene, and the like as well as mixtures thereof. Suitable probiotics include, for example Acidophilus Bifidobacterium, Lactobacillus Johnsonii, and the like as well as mixtures thereof. Suitable botanicals include, for example St. John's wort, ginseng, ginkgo biloba, and the like as well as mixtures thereof. Of course, as those skilled in the art will realize, other vitamins, minerals, antioxidants, probiotics, and botanticals can also be used in the present invention. The amount of such optional ingredients can, of course, vary considerably depending on the specific nutrient or mineral added (and its recommended daily requirement) and the targeted consumer. For example, macronuterients (e.g., calcium) can be added at relatively high levels (i.e., up to about 5 percent) whereas other trace minerals, vitamins, and other additives (i.e., generally materials having daily adult requirements in the milligram range or lower) will normally be added at much lower levels.

The acid solution, preferably an aqueous acid solution, is prepared by simply mixing or combining the components with gentle agitation to form an essentially homogenous slurry, suspension, or solution. The amount of acid added should be sufficient to provide a pH in the final product of about 4.6 to about 5, and preferably about 4.7 to about 4.8. If desired, and especially if spices or other ingredients that might contain microorganisms are included in the acid solution, the acid solution can be heated to, and held at, a temperature of greater than about 165° F. for about two minutes (or similar pasteurization conditions) and then cooled before addition to, or combination with, the food product.

The containers used in the present invention must be thermally stable under the in-pack pasteurization and storage conditions used herein. Preferably, such containers are also vacuum and/or heat sealable. Generally, plastic containers are preferred, with flexible pouches formed from thermo-plastic films being most preferred. Suitable materials for the containers include, for example, single layer or multiple layered plastics films, glass, and the like. Preferred thermoplastic films suitable for use in the present invention include nylon, polyethylene, polypropylene, laminates or metallized laminates thereof, and the like. Preferably the container should not allow the entry of oxygen and/or light in order to maintain the highest quality. In the case of transparent plastic container or pouches, a non-transparent outer package or carton may be used to exclude light if desired. Generally, plastic pouches normally used for frozen foods are suitable for use in the present invention.

The present invention can be used to prepare a wide variety food products. The food products which can be treated using the methods of this invention include vegetables (raw or cooked), cooked meat, rice, pasta, and the like, as well as mixtures thereof. The vegetables used in the present invention may be green, yellow, orange, and/or red vegetables. Such vegetables include, for example, carrots, various types of peppers, broccoli, various types of peas and pea-pods, cauliflower, onions, tomatoes, mushrooms, zucchini, corn, celery, asparagus, green beans, water chestnuts, bamboo shoots, and the like. Generally, the vegetables are first cut into appropriate sizes (generally pieces of ½ inch or less in their longest dimension); larger pieces can be used, if desired. Of course, smaller vegetables such as peas and pea-pods can be, and preferably are, used whole without any reduction in size. Both frozen (especially the individuallyly frozen type) vegetables and fresh vegetables can be used in the present invention. Preferably fresh vegetables are used in the present invention since they provide the highest quality in the final product. Generally, blanching of the vegetables prior to acidification should be avoided, if possible, since this additional thermal exposure can result in lose of quality. Likewise, fresh vegetables should be processed in the present invention as quickly as is reasonable in order to minimize enzymatic degradation. Examples of cooked meat products which may be packaged using the methods of this invention include, but are not limited to, beef, pork, poultry, seafood, and the like. Examples of pasta which may be packaged using the methods of this invention include, but are not limited to, macaroni, spaghetti, and the like.

The following examples are intended to illustrate the invention and not to limit it. Unless otherwise indicated, all percentages using in the present specification are by weight. All patents and publications referred to in the present specification are hereby incorporated by reference.

Example 1. Fresh, raw red bell peppers were washed and then cut into small pieces (about 0.5 by 0.5 inch squares). Cut vegetables (about 114 g) were placed in a plastic pouch (dimensions of about 4 to about 5 inches and about 1 inch thick when filled). The pouch was formed from a bilayer plastic film consisting of biaxially oriented nylon and ethylene vinyl alcohol (with sealant layer of linear low density polyethylene) from Curwood Inc., Oshkosh, Wis. An acid solution containing about 25 to about 38 g of 88% lactic acid and about 0.1 to about 0.2 percent salt was added to the vegetable in the pouch. The pouch was heat sealed and then heated in boiling water for about 6 to 7 minutes to achieve an internal temperature of about 160° F. for about 1 minute to pasteurize and inactivate enzymes in the bell peppers. The integrity and seal of the pouch were maintained under the thermal and mechanical stress of the pasteurization step. The heat treated pouch containing vegetables was then immediately cooled under running cold tap water for about 6 to about 7 minutes in order to reduce the internal temperature of the vegetables to about 40 to about 55° F. The cooled vegetables were immediately stored under refrigerated conditions until used.

Samples were periodically evaluated. The pH was less than 5.0; pH equilibration was reached within 24 hours of being placed in refrigerated storage. Complete inactivation of catalase enzyme in the vegetables was confirmed using a standard peroxide test (i.e., submerging treated vegetables in 3% hydrogen peroxide). Based on an evaluation by an expert panel, the inventive red bell peppers were found to be considerably better than IQF red bell peppers and similar to freshly prepared red bell peppers in color, taste, and flavor. High quality was maintained under refrigerated storage conditions for about 4 to about 6 months.

Example 2. This example illustrates the preparation of a meal kit comprising a meat component, a vegetable component, and a rice component using the process of the present invention. Sliced precooked beef and an acidified red sauce (e.g., tomato pureee, high fructose corn syrup, salt, modified starch, lactic acid, spice) having a pH of about 2 to about 3 could be gently mixed at about 40° F. until the equilibrium pH is lowered to about 4.7. The meat and sauce mixture could be placed in heat sealable, individual plastic pouches and heat sealed. The sealed pouches could be pasteurized in a hot water bath (about 210° F.) until the contents (i.e., center of meat components) reach about 160° F. for about 1 minute (or equivalent). The heat-treated pouches could then cooled in a spiral freezers to about 40° F. The resulting product could then immediately be stored under refrigerated conditions.

For the vegetable component, carrot strips and diced red bell peppers were placed together in a heat sealable plastic pouches. After added sufficient acid solution (i.e., about 0.1 to about 0.2 percent 88% lactic acid and about 0.1 percent salt) to achieve an equilibrium pH of less than about 4.8 in the final product, the pouches were heat sealed. The sealed pouches were then pasteurized in a hot water bath (about 210° F.) until the contents reached about 160° F. for about 1 minute (or equivalent). The heat-treated pouches were then cooled in a spiral freezers to about 40° F. The resulting product was immediately stored under refrigerated conditions.

For the rice component, blanched rice with sufficient acid solution (i.e., about 0.1 to about 0.2 percent 88% lactic acid and about 0.1 percent salt) to achieve an equilibrium pH of less than about 4.8 in the final product were placed in individual plastic pouches and heat sealed. The sealed pouches were then pasteurized in a hot water bath (about 210° F.) until the contents reached about 160° F. for about 1 minute (or equivalent). The heat-treated pouches were then cooled in a spiral freezers to about 40° F. The resulting product was immediately stored under refrigerated conditions.

The three components can be combined in a meal or dinner kit to provide a complete entree which can easily be prepared in the home kitchen. Similar entree having intermediate pH can also be produced by combining all three components with the appropriate acid solution and treating as described above. Preferably, however, any starch components (e.g., rice, pasta) are processed in a separate pouch to minimize potential texture deterioration (e.g., softening).

Example 3. This example illustrates the preparation of vegetables on a large scale using the inventive process. An acid blanch solution was prepared by heating the appropriate amount of water to 200° F. and then adding about 0.12 to about 0.4 percent 88% lactic acid and about 0.1 percent salt. An acidic rinse solution was prepared by adding about 0.06 to about 0.4 percent 88% lactic acid to cold water.

About 40 to 60 pounds of selected IQF vegetables were added to about 500 to about 600 pounds of the acid blanch solution heated to about 210° F. and maintained at that temperature for about 2.5 to about 5 minutes; about 1 percent canola oil was added with about 30 seconds left in the cooking cycle. After cooking, the acidified vegetables were drained while adding about 1000 to about 1100 pounds of the acidic rinse solution at about 40 to about 60° F. to cool the vegetables to a temperature of about 100° F. or lower. After draining, about 100 to about 120 g of the cooled acidified vegetables were placed in individual pouches and heat sealed using partial vacuum. The sealed pouches were then treated in a hot water bath to about 195° F. for about 17 to 27 minutes (sufficient to raise the internal temperature to about 160° F. for at least one minute). After heat treatment, the pouches were chilled with cold water to less than about 55° F. and then immediately stored under refrigerated conditions. The pH of the final treated product was about 4.7 to about 4.8.

The following table provides the specific vegetables and treatment conditions used are included in Table 1. The pH after processing and after equilibration (generally about 24 hours storage under refrigerated conditions) are shown in Table II. Foods or vegetables of high protein content (e.g., corn) generally required more acid to achieve the desired equilibrium pH (i.e., less than 5). Corn Sample 2 did not contain sufficient acid to provide a final product pH of less than 5, would exhibit significant spoilage under refrigerated conditions; this unacceptable sample is included for comparison purposes only. Samples 7 and 8 contained too much acid and had a pH of less than about 4.6. Although samples 7 and 8 would not present microbiological problems, they would have would have a significant acid taste; these unacceptable samples are included for comparison purposes only.

TABLE I

| | Vegetable | | Blanch Solution | | | | | Rinse Solution | |
|---|---|---|---|---|---|---|---|---|---|
| | | Amount | | 88% Lactic | | Canola Oil | Blanch Time | | 88% Lactic |
| Sample | Type | (lbs) | Water (lbs) | Acid (%) | Salt (%) | (lbs) | (min) | Water (lbs) | Acid (%) |
| 1 | Carrots | 45 | 600 | 0.2 | 0.1 | 1 | 4 | 1100 | 0.2 |
| 2 | Corn | 60 | 600 | 0.3 | 0.1 | 1 | 4 | 1100 | 0.2 |
| 3 | Corn | 60 | 600 | 0.4 | 0.1 | 1 | 4.5 | 1100 | 0.2 |
| 4 | Yellow Pepper | 60 | 600 | 0.15 | 0.1 | 1 | 2.5 | 1100 | 0.14 |
| 5 | Green Beans | 40 | 600 | 0.2 | 0.1 | 1 | 4 | 1100 | 0.2 |
| 6 | Green Beans | 40 | 600 | 0.2 | 0.1 | 1 | 4 | 1100 | 0.2 |
| 7 | Mushrooms | 60 | 500 | 0.4 | 0.1 | 1 | 4.25 | 1100 | 0.25 |
| 8 | Mushrooms | 60 | 500 | 0.4 | 0.1 | 1 | 4.25 | 1100 | 0.25 |

TABLE II

pH

| | After Rinse/ | After |
|---|---|---|
| Sample | Processing | Equilibration |
| 1 | 4.63 | 4.54 |
| 2 | 5.49 | 5.58* |
| 3 | 4.60 | 4.98 |
| 4 | 4.46 | 4.54 |
| 5 | 4.70 | 4.75 |
| 6 | 4.60 | 4.67 |
| 7 | 4.41 | 4.41* |
| 8 | 4.48 | 4.46* |

*Equilibrium pH is not acceptable.
Samples 2, 7, and 8 are included for comparison purposes only.

Example 4. This example illustrates the preparation of vegetables in an acidic marinade solution. The acidic marinade solution was prepared as an aqueous solution containing about 0.12 to about 0.4 percent 88 percent lactic acid, about 0.1 percent salt, about 0.2 percent sugar, and about 0.5 to about 2 percent herbs/spices. Marinade solution was added to freshly cut green and red bell peppers at a level of about 22 to about 44 percent at a temperature of about 40 to about 65° F. in a heat sealable pouch. The filled pouch was then sealed using partial vacuum and then treated in a hot water bath (about 210° F. for about 2.5 to about 9 minutes) to achieve an internal temperature of about 160° F. for about 1 minute. The heat treated pouch was then cooled in running cold water to less than about 55° F. and immediately stored under refrigerated conditions. The equilibrium pH of the resulting products was about 4.7. The resulting marinated bell peppers retained excellent appearance, texture, taste, and flavor (which was similar to that of freshly prepared bell peppers) for about 4 to about 6 months under refrigeration conditions. The color of the green bell peppers, however, did change from a bright green to an olive green; this was expected due to the effect of the equilibrium pH on chlorophyll.

Example 5. This example illustrates the method of this invention wherein bell peppers in an acidified Teriyaki sauce can be prepared. The sauce could be prepared as an aqueous mixture containing about 35 to 45 percent of high fructose corn syrup, about 20 to about 30 percent water, about 20 to about 30 percent soy sauce, about 7 to about 15 percent vinegar, about 2 to about 4 percent of modified starch, about 0.5 to about 2 percent flavors/herbs/spices, trace amount of food colors, and about 0.12 to about 0.4 percent lactic acid (88%). Sauce would be added to freshly cut red bell peppers at a level of about 30 to about 40 percent at a temperature of about 140 to about 160° F. in a heat sealable pouch. The filled pouch would then be sealed and treated in a hot water bath (about 210° F. for about 3 to about 8 minutes) to achieve an internal temperature of about 160° F. for about 1 minute. The heat treated pouch would then be cooled rapidly in running cold water to less than about 55° F. and stored under refrigerated conditions. The equilibrium pH of the resulting product is preferably about 4.7 to about 4.9. The resulting red bell peppers in the sauce are expected to retain excellent color, texture, taste, and flavor (similar to that of freshly prepared red bell peppers) for about 4 to about 6 months under refrigeration conditions.

We claim:

1. A method for preparing a preserved food product, said method comprising (1) combining a food product with an amount of an edible acid to obtain an acidified food product, wherein the amount is sufficient to achieve a pH of about 4.6 to about 5 in the preserved food product; (2) placing the acidified food product in a heat-stable, sealable container; (3) sealing the container; (4) thermally treating the food product in the sealed container at a temperature and for a time effective to pasteurize the food product; (5) cooling the thermally treated food product to rapidly reduce the temperature to below about 55° F.; and (6) storing the cooled food product under refrigerated conditions to obtain the preserved food product.

2. The method as defined in claim 1, wherein the food product is selected from the group consisting of vegetables, beans, meat, rice, pasta, and mixtures thereof.

3. The method as defined in claim 1, wherein the food product is selected from the group consisting of raw vegetables, partially cooked vegetables, and cooked vegetables.

4. The method as defined in claim 1, wherein the container is a plastic pouch.

5. The method as defined in claim 2, wherein the container is a plastic pouch.

6. The method as defined in claim 3, wherein the container is a plastic pouch.

7. A method for preparing a preserved food product, said method comprising (1) placing a food product in a sealable, heat stable container; (2) adding an amount of an edible acid to the container, wherein the amount is sufficient to achieve a pH of about 4.6 to about 5 in the preserved food product; (3) sealing the container; (4) thermally treating the food product in the sealed container at a temperature and for a time effective to pasteurize the food product; (5) cooling the thermally treated food product to rapidly reduce the temperature to below about 55° F.; and (6) storing the cooled food product under refrigerated conditions to obtain the preserved food product.

8. The method as defined in claim 7, wherein the food product is a vegetable and wherein food product placed in the sealable, heat stable container is raw or partially cooked vegetables.

9. The method as defined in claim 8, wherein the food product placed in the sealable, heat stable container is raw vegetables and wherein the container is a plastic pouch.

10. The method as defined in claim 8, wherein at least one of the ingredients selected from the group consisting of salt, sweeteners, oils, emulsifiers, thickeners, spices, flavorants, colorants, preservatives, nutrients, vitamins, minerals, antioxidants, probiotics, botanicals, and nutraceutical additives is added to the container prior to sealing.

11. The method as defined in claim 9, wherein at least one of the ingredients selected from the group consisting of salt, sweeteners, oils, emulsifiers, thickeners, spices, flavorants, colorants, preservatives, nutrients, vitamins, minerals, antioxidants, probiotics, botanicals, and nutraceutical additives is added to the container prior to sealing.

12. The method as defined in claim 8, wherein the food product is selected from the group consisting of carrots, peppers, broccoli, peas, pea-pods, cauliflower, onions, tomatoes, mushrooms, zucchini, corn, celery, asparagus, green beans, water chestnuts, and bamboo shoots.

13. The method as defined in claim 9, wherein the food product is selected from the group consisting of carrots, peppers, broccoli, peas, pea-pods, cauliflower, onions, tomatoes, mushrooms, zucchini, corn, celery, asparagus, green beans, water chestnuts, and bamboo shoots.

14. The method as defined in claim 9, wherein the food product is pretreated to reduce the initial microbiological load.

15. The method as defined in claim 11, wherein the food product is pretreated to reduce the initial microbiological load.

16. The method as defined in claim 13, wherein the food product is pretreated to reduce the initial microbiological load.

17. A method for preparing preserved vegetables, said method comprising (1) pretreating raw vegetables in order to reduce the initial microbiological load; (2) placing the pretreated raw vegetables in a sealable, heat stable plastic pouch; (3) adding an amount of an edible acid to the container, wherein the amount is sufficient to achieve a pH of less than about 5 in the preserved vegetables; (4) sealing the container; (5) thermally treating the vegetables in the sealed container at a temperature and for a time effective to pasteurize the food product; (6) cooling the thermally treated vegetables to rapidly reduce the temperature to below about 55° F.; and (7) storing the cooled vegetables under refrigerated conditions to obtain the preserved vegetables.

18. The method as defined in claim 17, wherein at least one of the ingredients selected from the group consisting of salt, sweeteners, oils, emulsifiers, thickeners, spices, flavorants, colorants, preservatives, nutrients, vitamins, minerals, antioxidants, probiotics, botanicals, and nutraceutical additives is added to the plastic pouch prior to sealing.

19. The method as defined in claim 17, wherein the vegetables are selected from the group consisting of carrots, peppers, broccoli, peas, pea-pods, cauliflower, onions, tomatoes, mushrooms, zucchini, corn, celery, asparagus, green beans, water chestnuts, and bamboo shoots.

20. The method as defined in claim 18, wherein the vegetables are selected from the group consisting of carrots, peppers, broccoli, peas, pea-pods, cauliflower, onions, tomatoes, mushrooms, zucchini, corn, celery, asparagus, green beans, water chestnuts, and bamboo shoots.
